(19) United States
(12) Patent Application Publication
(10) Pub. No.: US 2004/0119359 A1
(43) Pub. Date: Jun. 24, 2004

(54) Automotive alternator stator assembly with odd number of electrical turns

(75) Inventor: Kirk E. Neet, Saline, MI (US)

Correspondence Address: VISTEON 29074, BRINKS HOFER GILSON & LIONE, P.O. BOX 10395, CHICAGO, IL, 60611, US

(73) Assignee: Visteon Global Technologies, Inc.

(21) Appl. No.: 10/324,408

(22) Filed: Dec. 19, 2002

(51) Int. Cl. H02K 1/00; H02K 3/00; H02H 7/06

(52) U.S. Cl. 310/184; 310/254; 310/180; 322/28

(57) ABSTRACT

A stator core assembly for an electric machine of the type having a rotor assembly and a stator assembly having at least one phase and having an annular core defining an outside diameter, an inside diameter, and a plurality of radially projecting winding slots opening to the inside diameter but terminating short of the outside diameter. The stator core further comprising a plurality of layers, N, each layer including a first continuous electrical conductor designated as A conductor and a second continuous electrical conductor designated as B conductor, thereby including two electrical conductors per layer and an even number of electrical conductors in total. A plurality of electrical connections in between and interconnecting the conductors includes at least one parallel connection and one series connection, such that the plurality of connections define an odd number of electrical turns.

### FIELD OF INVENTION

The invention relates to an automotive electrical alternator, and particularly to an alternator having a stator winding configuration having an even number of conductors and providing an odd number of electrical turns.

### BACKGROUND OF THE INVENTION

This invention is related to an electrical alternator, of a type particularly adapted for use in motor vehicle applications including passenger cars and light trucks. These devices are typically mechanically driven using a drive belt wrapped on a pulley connected to the crankshaft of the vehicle's internal combustion engine. The belt drives a pulley on the alternator which rotates an internal rotor assembly to generate alternating current (AC) electrical power. This alternating current electrical power is rectified to direct current (DC) and supplied to the motor vehicle's electrical bus and storage battery.

While alternators have been in use in motor vehicles for many decades, today's demands on motor vehicle design, cost, and performance have placed increasing emphasis on the design of more efficient alternators. Today's motor vehicles feature a dramatic increase in the number of electrical on-board systems and accessories. Such electrical devices include interior and exterior lighting, climate control systems; and increasingly sophisticated power train control systems, vehicle stability systems, traction control systems, and anti-lock brake systems. Vehicle audio and telematics systems place further demands on the vehicle's electrical system. Still further challenges in terms of the output capacity of the motor vehicle's electrical alternators will come with the widespread adoption of electrically assisted power steering and electric vehicle braking systems. Compounding these design challenges is the fact that the vehicle's electrical system demands vary widely, irrespective of the engine operating speed which drives the alternator and changes through various driving conditions.

In addition to the challenges of providing high electrical output for the vehicle electrical alternator, further constraints include the desire to minimize the size of the alternator with respect to under hood packaging limitations, and its mass which relates to the vehicle's fuel mileage.

In addition to the need of providing higher electrical output, designers of these devices further strive to provide high efficiency in the conversion of mechanical power delivered by the engine driven belt to electrical power output. Such efficiency translates directly into higher overall thermal efficiency of the motor vehicle and thus into fuel economy gains. And finally, as is the case with all components for mass-produced motor vehicles, cost remains a factor in the competitive offerings of such components to original equipment manufacturers.

Enhanced efficiency of the alternator can be provided through various design approaches. The alternator uses a rotating rotor assembly, which creates a rotating alternating polarity magnetic field. This rotating alternating polarity magnetic field is exposed to an annular stator core assembly which closely surrounds the rotor assembly. Electrical conductor windings are embedded within the stator core assembly. A number of design challenges are presented with respect to the design and manufacturing of the stator core assembly which includes a stator core and the windings. The stator core has a series of radially projecting slots. Some alternator designs employ conventional wire conductors having a round cross sectional shape laced into the stator core winding slots. These round cross-sectional wires are nested against other turns of wire in the slots. The use of such round wire produces air spaces between adjacent turns of wire. This air space represents unused space in the cross section of the stator core. Electrical resistance through a solid conductor is related to its cross sectional area. Consequently, the air space between adjacent turns of a round wire stator represents inefficiency since that space is not being used to carry electrical current through the stator windings.

One improved design of stator core assembly uses stator windings formed of rectangular or square cross sectional wire. Such wire can be laced into the stator core winding slots in a very densely packed configuration. This allows larger cross sectional areas to be provided for the conductors, thus lowering the conductor's resistance. Reducing the stator core winding resistance improves efficiency. Such rectangular wire core designs are said to improve “slot space utilization”.

Although rectangular cross section wire for the stator core assembly provides the previously noted benefits, its use produces a number of design challenges. Rectangular cross section wire is more difficult to form and wind into the stator winding slots, since it is necessary to align the cross section to the slot dimensions.

Since the stator conductors are laced from the two axial ends of the stator core, they are looped at their ends to pass into the next appropriate winding slot. It is desirable to reduce the length or height of these end loops as a means of reducing the total length and therefore the internal resistance of the conductors.

Designers of stator assemblies further attempt to reduce or eliminate the need for providing electrical conductor terminations and connections in the stator assembly. The necessity to physically connect conductors in the stator core assembly adversely impacts cost and complexity of the manufacturing process. An advantageous design of an alternator stator assembly would enable the stator assembly to be readily adapted for various types of electrical connections and number of phases of produced alternating current. Automotive electrical alternators are often manufactured in a three-phase configuration with the phases connected in the familiar delta or wye connections. As mentioned previously, the alternating current output is later rectified and conditioned by downstream electrical devices.

A particular technique of winding the continuous conductors onto the stator core that improves many of the conditions discussed above is disclosed in U.S. patent application Ser. No. 10/056,890 filed on Jan. 24, 2002, entitled “Automobile Alternator Stator Assembly With Rectangular Continuous Wire”, and Continuation In Part application Ser. No. 10/265,529, filed on Oct. 8, 2002, entitled “Automobile Alternator Stator Assembly With Rectangular Continuous Wire”. These two patent applications disclose a particular method of winding continuous rectangular conductors onto the stator core, are assigned to the assignee of the present application, and are hereby incorporated by reference into this application. The winding technique discussed in these applications requires the use of an even number of electrical conductors, which typically leads to an even number of electrical turns. In order to meet the performance requirements of some stator designs, in some instances, it would be desirable to have a stator assembly which has an odd number of electrical turns, and uses the winding techniques of the previously filed applications.

Therefore, there is a need for a stator core assembly having and even number of continuous electrical conductors and providing an odd number of electrical turns.

### SUMMARY OF THE INVENTION

The automotive alternator stator core assembly in accordance with this invention addresses each of the design and manufacturing goals previously noted. The alternator stator core assembly in accordance with this invention utilizes a unique winding pattern particularly advantageously used with rectangular cross section stator winding conductors, as disclosed in U.S. patent application Ser. No. 10/056,890 filed on Jan. 24, 2002, entitled “Automobile Alternator Stator Assembly With Rectangular Continuous Wire”, and Continuation In Part application Ser. No. 10/265,529, filed on Oct. 8, 2002, entitled “Automobile Alternator Stator Assembly With Rectangular Continuous Wire”. The design features high slot space utilization, eliminates the necessity for providing internal welds or other connections for the conductors, and features low-end loop height. The design is further highly flexible, providing a plurality of electrical connections between the conductors, thus enabling the stator assembly to provide an odd number of electrical turns by structuring parallel and series electrical connections between the electrical conductors.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a cross sectional view of a typical prior art electrical alternator;

FIG. 2 is an end view of a stator core of the stator core assembly in accordance with this invention;

FIGS. 3 and 4 are schematic diagrams of the conductors of a first preferred embodiment;

FIGS. 5 and 6 are schematic diagrams of the conductors of a second preferred embodiment;

FIGS. 7 and 8 are schematic diagrams of the conductors of a third preferred embodiment;

FIG. 9 illustrates alternative cross sectional shapes for the conductors; and

FIG. 10 illustrates how the conductors fit closely within the slots of the stator core.

### DESCRIPTION OF THE PREFERRED EMBODIMENTS

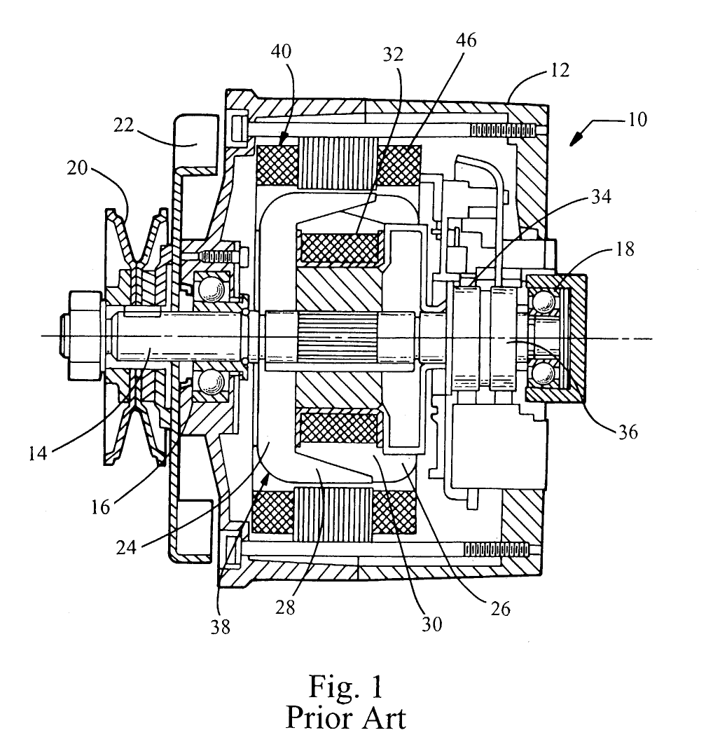

In order to provide a framework for a further detailed description of the preferred embodiments of this invention, FIG. 1 is presented illustrating a prior art electrical alternator configuration. FIG. 1 illustrates an electrical alternator 10 enclosed with a housing 12. An alternator rotor shaft 14 is supported by a pair of rolling element bearings 16, 18. A belt driven pulley 20 is fastened to the protruding front end of the rotor shaft 14. A fan 22 rotates with the shaft 14 and provides cooling airflow for removing heat from the alternator 10. A rotor assembly 38 includes front and rear alternator poles pieces 24 and 26 that rotate with the shaft 14 and have extending claw fingers 28 and 30, respectively. The fingers 28 and 30 interlace to create the well known “claw pole” rotor configuration. Although the “claw pole” rotor is described, one skilled in the art will recognize that the described stator design can be used in conjunction with other types of rotors, such as; permanent magnet non claw pole, permanent magnet claw pole, salient field wound and induction type rotors. An excitation winding 32 is carried within the cavity formed between pole pieces 24 and 26. A DC signal is applied to the excitation winding 32 through a pair of slip rings 34 and 36, and associated brushes.

A stator assembly 40 having stator windings 42 is mounted within the housing 12 in functional engagement with the rotor assembly 38. The rotor assembly 38 produces an alternating polarity magnetic field which rotates with rotation of the rotor assembly 38. Although a DC excitation signal is applied to the slip rings 34, 36, the interlacing of the pole pieces 24, 26 creates an alternating polarity magnetic field as presented to the windings 42 of the stator core assembly 40 located radially around rotor assembly 38. The movement of the alternating polarity magnetic field presented by the rotor assembly 38 across the stator core windings 42 generates electricity in a well-known manner.

Electrical energy produced by electrical alternator 10 generated within core assembly 40 is directed to rectifying diodes (not shown) and perhaps further filtering and power conditioning devices before being connected with the vehicle's electric distribution bus. Control systems, also known as voltage regulators, are used to apply an appropriate level of DC voltage to the windings 32 to generate the desired RMS value of the outputted alternating current from alternator 10, which can be in single phase or multi-phase form, depending on the design and winding pattern of the stator windings 42.

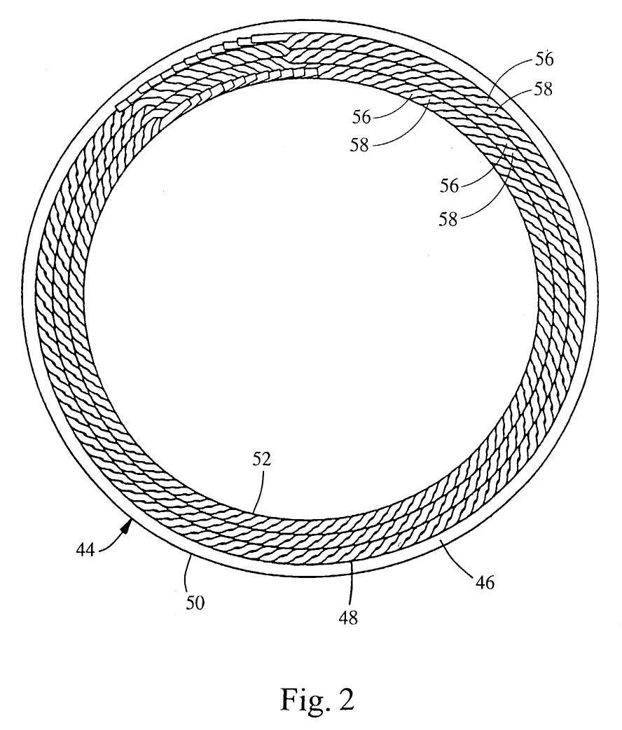

Referring to FIG. 2, a stator core assembly in accordance with the present invention is shown generally at 44. The stator core assembly 44 principally comprises a stator core 46 and conductor windings 48. The stator core 46 is an annular metallic component defining outside diameter 50, and an inside diameter 52 with radially projecting winding slots 54. The winding slots 54 open toward the inside diameter 52, but include a bottom in the radially outer direction before reaching outside diameter 50. The winding slots 54 are provided at equal angular increment positions around the stator core 46.

The windings 48 are comprised of rectangular cross section electrical conductors 56, 58. Reference to rectangular is, of course, intended to include square cross sectional shapes. Preferably, the width of the conductors 56, 58, including any insulation on the conductors 56, 58 is such that the conductors 56, 58 fit closely within the winding slots 54, including any insulation within the slots 54. These conductors 56, 58 are loaded into the slots 54 in a densely packed configuration, with adjacent winding turns overlaid on one another in the radial direction.

The winding pattern of the conductors is discussed in more detail in U.S. patent application Ser. No. 10/056,890 filed on Jan. 24, 2002, entitled “Automobile Alternator Stator Assembly With Rectangular Continuous Wire”, and Continuation In Part application Ser. No. 10/256,529, filed on Oct. 8, 2002, entitled “Automobile Alternator Stator Assembly With Rectangular Continuous Wire”, which are assigned to the assignee of the present application and are hereby incorporated by reference into the present application.

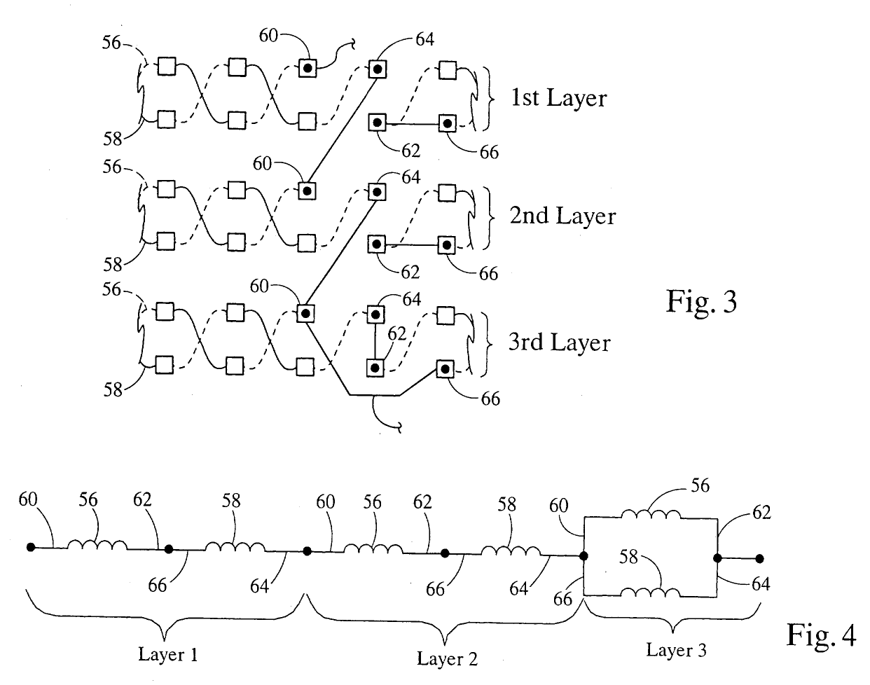

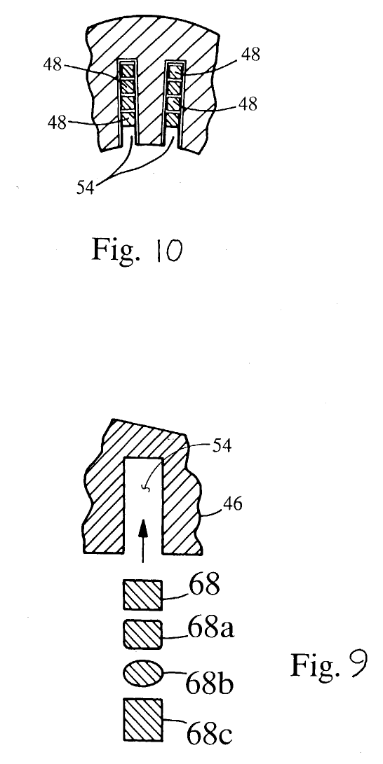

Referring to FIGS. 2 and 9 the windings 48 are comprised of a plurality of layers, N, each layer having two individual conductors 56, 58 per phase. The conductors are each continuous wires (i.e. not formed by mechanically joining separate lengths of conductor). For each phase, the two conductors 56, 58 within each layer are designated as the A conductor 56 and the B conductor 58, and they are aligned in one radial row within the winding slots 54. In each winding slot 54, this row extends radially from the “bottom” of each winding slot 54 near the outside diameter 50 of the stator core 46, to an inner position toward the inner diameter 52 of the stator core 46. A plurality of electrical connections are formed between the layers, including being formed by continuous conductors that pass between the layers. Preferably, there is at least one parallel connection and at least one series connection, such that an odd number of electrical turns are defined by the stator core assembly 44. As mentioned previously, a three-phase configuration is commonly used by six-phase designs may also be provided. However, for a simplified illustration, FIGS. 3-8 show only one phase of a multi-phase electrical machine.

Referring to FIGS. 3 and 4, in a first preferred embodiment, layers 1 through N-1 include a series set and layer N includes a parallel set. As shown, there are three layers, such that the first and second layers each includes a series set, and the third layer includes a parallel set. Each series set is defined as the A conductor 56 and the B conductor 58 of a particular layer being connected to one another in series. Each series set defines two electrical turns. More specifically, each of the A conductors 56 includes a first end 60 and a second end 62, and each of the B conductors 58 includes a first end 64 and a second end 66. A series set is defined as the A conductor 56 and the B conductor 58 of each of the layers 1 through N-1wherein the second end 62 of the A conductor 56 is connected to the second end 66 of the B conductor 58. An electrical current will pass into the first end 60 of the A conductor 56, through the A conductor 56 once around the stator core 46, from the second end 62 of the A conductor 56 to the second end 66 of the B conductor 58, and through the B conductor 58 a second time around the stator core 46, thereby providing two electrical turns. From there, the current passes from the first end 64 of the B conductor into the first end of the A conductor of the next adjacent layer.

The parallel set of Layer N, or the third layer as shown, is defined as the A conductor 56 and the B conductor 58 of layer N being connected to one another in parallel. The parallel set defines a single electrical turn. More specifically, the parallel set is defined as the A conductor 56 and the B conductor 58 of Layer N wherein the first end 60 of the A conductor 56 is connected to the second end 66 of the B conductor 58 and the second end 62 of the A conductor 56 is connected to the first end 64 of the B conductor 58. An electrical current will pass into the first end 60 of the A conductor 56 and the second end 66 of the B conductor 58 simultaneously, and pass through the A and B conductors 56, 58 around the stator core 46 simultaneously, thereby providing one electrical turn.

The series sets and the parallel set are connected to one another in series thereby defining and odd number, 2N-1, or five as shown, of electrical turns. More specifically, the first end 64 of the B conductor 58 of each of the series sets in the layers 1 through N-1, or layers 1 and 2 as shown, are connected to the first end 60 of the A conductor 56 of the next adjacent layer. Further, the first end 60 of the A conductor 56 of the series set of the first layer is connected, to a pair of rectifying diodes (not shown), and the second end 62 of the A conductor 56 and the first end of the B conductor 58 of the parallel set of layer N are connected to either a pair of rectifying diodes (not shown) or to the neutral point (not shown) to form the widely known “wye” or “delta” type electrical circuits along with the remaining phases.

Preferably, the cross sectional area of the conductors 56, 58 in the series sets is roughly twice the cross sectional area of the conductors 56, 58 in the parallel sets. This is necessary to keep the electrical resistance within the series sets and the parallel sets roughly equal.

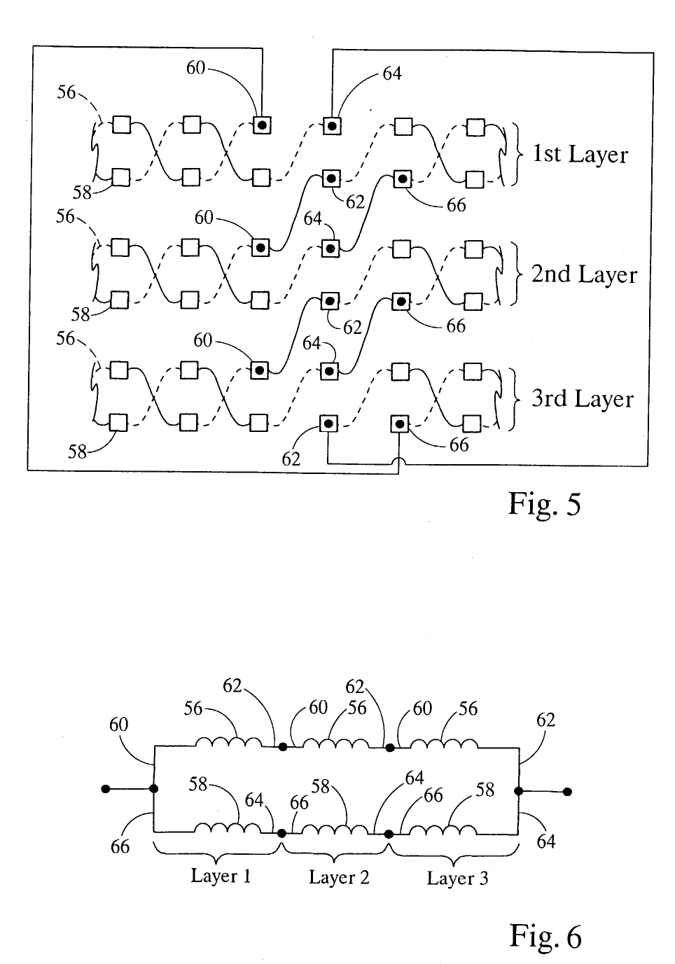

Referring to FIGS. 5 and 6, in a second preferred embodiment, the stator core assembly 44 has an odd number of layers, N. As shown, the stator core assembly 44 has three layers. The stator core assembly 44 includes a pair of series sets that each define N electrical turns and the series sets are connected to one another in parallel such that the stator core assembly 44 defines N electrical turns, or three electrical turns as shown.

More specifically, the second preferred embodiment includes a first series set and a second series set. The second end 62 of each of the A conductors 56 of layers 1 through N-1, or layers one and two as shown, is connected to the first end 60 of the A conductor 56 of the next adjacent layer to define the first series set, and the second end 66 of each of the B conductors 58 of layers 1 through N-1, the first and second layers as shown, is connected to the first end 64 of the B conductor 58 of the next adjacent layer to define the second series set.

The first end 60 of the A conductor 56 of the first layer is connected to the second end 66 of the B conductor 58 of layer N, and the second end 62 of the A conductor 56 of layer N is connected to the first end 64 of the B conductor 58 of the first layer, such that the first series set and the second series set are connected in parallel. An electrical current will pass through each of the first and second series sets, passing around the stator core assembly once for each layer for each of the first and second series sets simultaneously, thereby defining N, or three as shown, electrical turns. The first end 60 of the A conductor 56 of the first layer and the second end of the B conductor 58 of layer N are connected to each other and the first end 64 of the B conductor 58 of the first layer and the second end 62 of the A conductor 56 of layer N are connected to each other, and all are further connected, along with the conductor ends of the remaining phases, to a pair of rectifying diodes (not shown) or to a neutral point (not shown) to form the widely known “wye” or “delta” type circuits.

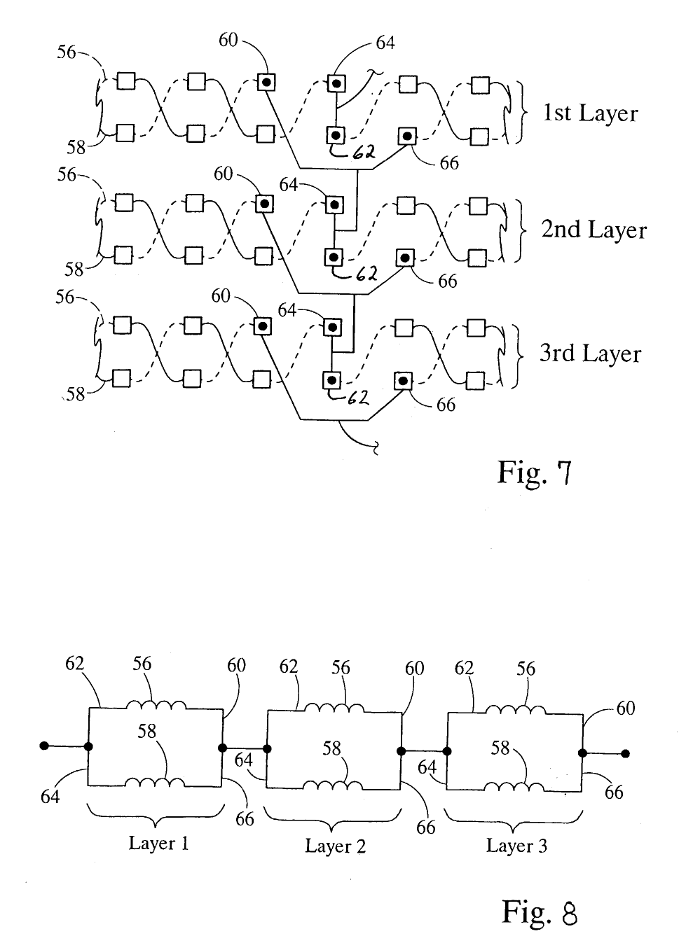

Referring to FIGS. 7 and 8, in a third preferred embodiment, the stator core assembly 44 has an odd number of layers, N, or three as shown. The stator core assembly 44 further has N parallel sets each defining a single electrical turn. The parallel sets are connected to one another in series, thereby defining N electrical turns.

More specifically, the parallel sets are defined as the A conductor 56 and the B conductor 58 of each individual layer, wherein the first end 60 of the A conductor 56 is connected to the second end 66 of the B conductor 58 and the second end 62 of the A conductor 56 is connected to the first end 64 of the B conductor 58 for each layer. Further, the first end 60 of the A conductor and the second end 66 of the B conductor for layers 1 through N-1 are connected to the first end 64 of the B conductor 58 and the second end 62 of the A conductor 46 of the next adjacent set. Finally, the first end 64 of the B conductor 58 and the second end 62 of the A conductor of the first layer are connected to a pair of rectifying diodes (not shown) and the first end 60 of the A conductor 56 and the second end 66 of the B conductor 58 of layer N are connected to a pair of rectifying diodes (not shown) or to the neutral point (not shown) to form the widely known “wye” or “delta” electrical circuits along with the remaining phases.

FIG. 9 illustrates alternative cross sectional shapes for the conductors 56, 58. In FIG. 9, the rectangular shape is designated by reference number 68. 68a represents a rectangular cross section with radiused corners. 68b represents an ellipse shaped cross section and 68c represents a square cross sectional shape. FIG. 10 illustrates how the conductors 56, 58 fit closely within the slots 54, aligned in one radial row.

While the above description constitutes the preferred embodiments of the present invention, it will be appreciated that the invention is susceptible to modification, variation and change without departing from the proper scope and fair meaning of the accompanying claims.

We claim:

1. A stator core assembly for an electric machine of the type having a rotor assembly and a stator assembly, said stator assembly of the type having at least one phase and having an annular core defining an outside diameter, an inside diameter, and a plurality of radially projecting winding slots opening to said inside diameter but terminating short of said outside diameter, said stator core assembly further comprising:
a plurality of layers, N, loaded into said slots, each of said layers including a first electrical conductor designated as an A conductor and a second electrical conductor designated as a B conductor per phase, thereby including two of said electrical conductors per layer, N, and an even total number of electrical conductors within said stator core assembly per phase;
said A and B conductors installed in said stator core assembly, such that said A and B conductors are aligned in one radial row within said slots.
at plurality of electrical connections between said conductors including at least one parallel connection and one series connection, said plurality of connections defining an odd number of electrical turns.

2. The stator core assembly for an electric machine of claim 1 wherein layers 1 through N-1 include a series set and layer N includes a parallel set, said series sets being defined as said A conductor and said B conductor of a particular layer being connected to one another in series, thereby defining two electrical turns, and said parallel set being defined as said A conductor and said B conductor of a particular layer being connected to one another in parallel, thereby defining a single electrical turn, said series sets and said parallel set being connected to one another in series thereby defining 2N-1 electrical turns.

3. The stator core assembly for an electric machine of claim 2 wherein each of said A conductors and each of said B conductors includes opposing first and second ends, wherein:
a series set is defined as the A conductor and the B conductor of a particular layer wherein said second end of said A conductor is connected to said second end of said B conductor;
a parallel set is defined as said A conductor and said B conductor of a particular layer wherein said first end of said A conductor is connected to said second end of said B conductor and said second end of said A conductor is connected to said first end of said B conductor; and
said first end of said B conductor of each of said series sets in said layers 1 through N-1 being connected to said first end of said A conductor of a next adjacent set; said first end of said B conductor of said layer N-1 being connected to said first end of said A conductor and said second end of said B conductor of said parallel set of said layer N.

4. The stator core assembly of claim 3 wherein said first end of said A conductor of said layer 1 is connected to a diode pair or said first end of said B conductor and said second end of said A conductor of said layer N are connected to a diode pair.

5. The stator core assembly of claim 3 wherein a cross sectional area of said conductors of said series sets is approximately twice that of said conductors of said parallel set.

6. The stator core assembly for an electric machine of claim 1 having an odd number of layers, wherein the number of layers is defined as N, said stator core assembly having a pair of series sets each defining N electrical turns, said series sets being connected to one another in parallel such that said stator core assembly defines N electrical turns.

7. The stator core assembly for an electric machine of claim 6 wherein each of said A conductors and each of said B conductors includes opposing first and second ends, wherein:
a first series set is defined as each of said A conductors wherein said second end of said A conductor of said layers 1 through N-1 is connected to said first end of said A conductor of a next adjacent layer;
a second series set is defined as each of said B conductors wherein said second end of said B conductor of said layers 1 through N-1 is connected to said first end of said B conductor of a next adjacent layer; and
said first end of said A conductor of said layer 1 being connected to said second end of said B conductor of said layer N and said second end of said A conductor of said layer N being connected to said first end of said B conductor of said layer 1, such that said first series set and said second series set are connected in parallel.

8. The stator core assembly for an electric machine of claim 7 wherein each said phase is comprised of only two continuous conductors, said A and B conductors, that pass through each said layer thereby completing said series connections.

9. The stator core assembly for an electric machine of claim 7 wherein said first end of said A conductor of said layer 1 connected to said second end of said B conductor of said layer N are connected to a diode pair or said second end of said A conductor of said layer N connected to said first end of said B conductor of said layer 1 are connected to a diode pair.

10. The stator core assembly for an electric machine of claim 1 having an odd number of layers, wherein the number of layers is defined as N, said stator core assembly having N parallel sets each defining a single electrical turn, said parallel sets being connected to one another in series such that said stator core assembly defines N electrical turns.

11. The stator core assembly for an electric machine of claim 10 wherein each of said A conductors and each of said B conductors includes opposing first and second ends, wherein:
a parallel set is defined as said A conductor and said B conductor of a particular layer wherein said first end of said A conductor is connected to said second end of said B conductor and said second end of said A conductor is connected to said first end of said B conductor for each of said layers;
said first end of said A conductor and said second end of said B conductor of each of said layers 1 through N-1 being connected to said first end of said B conductor and said second end of said A conductor of a next adjacent layer.

12. The stator core assembly of claim 11 wherein said first end of said B conductor and said second end of said A conductor of said layer 1 are connected to a diode pair or said first end of said A conductor and said second end of said B conductor of said layer N are connected to a diode pair.

13. The stator core assembly for an electric machine according to claim 1 wherein said A and B conductors have a substantially rectangular cross-sectional shape.

14. The stator core assembly for an electric machine according to claim 1 wherein said A and B conductors have a substantially square cross-sectional shape.

15. The stator core assembly for an electric machine according to claim 1 wherein said A and B conductors, including any insulation thereon, have a width of a dimension to be closely received by said winding slots, including any insulation on said winding slots.
